(19) United States
(12) Patent Application Publication
(10) Pub. No.: US 2026/0042299 A1
(43) Pub. Date: Feb. 12, 2026

(54) IDENTIFICATION CARD PRINTER THERMAL PRINT HEAD WITH CUSTOM THERMAL COMPENSATION ROUTINE DETERMINATION

(71) Applicant: Entrust Corporation, Shakopee, MN (US)

(72) Inventors: Nathan GOENNER, Shakopee, MN (US); Wade KRAGTORP, Shakopee, MN (US); Brett McDONOUGH, Shakopee, MN (US)

(21) Appl. No.: 19/292,215

(22) Filed: Aug. 6, 2025

Related U.S. Application Data
(60) Provisional application No. 63/679,788, filed on Aug. 6, 2024.

(51) Int. Cl. B41J 2/365; B41J 3/38; B41J 3/50

(52) U.S. Cl. CPC B41J 2/365; B41J 3/385; B41J 3/50; B41J 2202/35; B41J 2202/38

(57) ABSTRACT

A card printing system having a thermal print head and a thermal print ribbon is described. Operation of the thermal print head is controlled using a custom (or new) thermal compensation routine that is generated based on an analysis of test printing that is applied using the thermal print head and the thermal print ribbon onto a test card using a pre-generated thermal compensation routine. Once the custom thermal compensation routine is generated, the custom thermal compensation routine can then be used to print on a card, with the resulting printing being of higher quality than printing resulting from use of the pre-generated thermal compensation routine.

### PRIORITY

This application claims priority to U.S. Application No. 63/679,788 filed on Aug. 6, 2024, the entire contents of which are incorporated herein by reference.

### FIELD

This technical disclosure relates to thermal printing on identification documents such as cards including, but not limited to, cards used as financial (e.g., credit, debit, or the like) cards, access cards, driver's licenses, national identification cards, business identification cards, gift cards, and other cards.

### BACKGROUND

Some card printing systems print on cards or other identification documents using a thermal print head and a print ribbon that includes a carrier film and one or more transferrable colorants, which may be referred to as pigments or dyes, on the carrier film. The print ribbon may be a multi-color ribbon having repeating sequences of panels of different color donor layers applied to one side of the carrier film, or a monochromatic ribbon having a single-colorant donor layer applied to one side of the carrier film. The printing applied to the card can be a multicolor image, such as a portrait image of the intended card holder, or monochromatic data such as alphanumeric card holder data.

In a typical card printing application, the thermal print head applies heat to the side of the carrier film opposite the colorant donor layer(s) while the colorant donor layer is in contact with the card or other substrate to be printed. The heat causes the colorant to move from the colorant donor layer of the print ribbon onto the card substrate.

It is known to adjust the power applied to the thermal print head during printing to thermally compensate for temperatures of the heat elements (i.e. pixels) of the thermal print head based on a heat table that dictates how much energy to deliver to each pixel. This is generally called thermal compensation. A goal of thermal compensation for thermal print heads is to accurately control the temperature of each pixel during printing. Achieving the correct pixel temperature means proper transfer of colorant to the card. If the pixel temperature is too high, there is a risk of printing on areas of the card surface that are not supposed to be printed on and/or tearing the print ribbon. If the pixel temperature is too low, inadequate colorant gets transferred to the card surface.

In card printing systems, it is known to provide pre-generated thermal compensation routines (in the form of pre-generated heat tables) that a user can select from to print on their cardstock. When the user introduces new cardstock, the user would select one of the pre-generated thermal compensation routines that the user believes results in the best printing on their new cardstock. In some cases, the resulting printing using the selected pre-generated thermal compensation routine might be acceptable, but in other cases it may result in non-optimal printing.

### SUMMARY

A card printing system having a thermal print head and a thermal print ribbon is described. Operation of the thermal print head is controlled using a custom (or new) thermal compensation routine. The custom thermal compensation routine is generated based on an analysis, which can be manual or automated, of test printing that is applied on a test card using the thermal print head and the thermal print ribbon and using a pre-generated thermal compensation routine. Once the custom thermal compensation routine is generated, the custom thermal compensation routine can then be used to print on a card, with the resulting printing being of higher quality than printing resulting from use of the pre-generated thermal compensation routine.

As used in this description and claims, thermal compensation is intended to refer to the determination of the amount of energy to deliver to each heat element or pixel of the thermal print head for each print column to produce the desired image on the card. A thermal compensation routine refers to the entirety of the energy amounts to be delivered to the pixels, for example in the form of a heat table or look-up table. In card printing, many card printers operate with the card and the thermal print head moving relative to one another along a length direction of the card during printing, with the intended printing occurring in print columns perpendicular to the length direction, where a print column involves controlling the pixels on the print head for a single-pixel-width as the card and the print head traverse one another. The amount of energy delivered to each pixel is dictated by a heat table (or look-up table).

In an embodiment, generating the custom thermal compensation routine as described herein involves generating a new heat table that changes, compared to a pre-generated heat table, the energy delivered to one or more pixels of the thermal print head when the custom thermal compensation routine is applied. The new heat table may be a modification of the pre-generated heat table of the pre-generated thermal compensation routine. In an embodiment, one or more energy values of a pre-generated heat table are modified to create the new heat table. In another embodiment, a plurality of energy values of a pre-generated heat table are modified to create the new heat table. Alternatively, the new heat table may be newly created and not based on a pre-generated heat table.

The test printing on the test card using the pre-generated thermal compensation routine may be monochromatic and/or multi-color. The printing on the card using the custom thermal compensation routine may be monochromatic and/or multi-color. In an embodiment, the colorant that is printed on the test card using the pre-generated thermal compensation routine can match the colorant that is printed on the card using the custom thermal compensation routine. For example, if the printing on the test card using the pre-generated thermal compensation routine is monochromatic, then the printing on the card using the custom thermal compensation routine may also be monochromatic. Similarly, if the printing on the test card using the pre-generated thermal compensation routine is multi-color, then the printing on the card using the custom thermal compensation routine may also be multi-color.

The custom thermal compensation routine may be generated based on one or more user inputs that are input after printing on the test card and analyzing the test printing. For example, the user inputs may be the user adjusting energy levels, up or down, to be applied to various pixels that are selected by the user that results in adjustment of the energy values to those selected pixels to create the new heat table.

In another embodiment, the custom thermal compensation routine is not generated based on user input(s) but is instead automatically generated based on an automatic analysis of the test printing on the test card. For example, an image of the test printing can be automatically captured, for example using a camera, and automatically analyzing the test printing. The camera may be located in the card printing system whereby the image of the test printing is captured while the test card is in the card printing system. Alternatively, the camera may be located outside of the card printing system whereby the image of the test printing is captured while the test card is outside of the card printing system.

In an embodiment, the custom thermal compensation routine is generated a relatively short time after printing on the test card. For example, generation of the custom thermal compensation routine may be part of a maintenance routine on the card printing system, with the custom thermal compensation routine being generated within minutes of the printing on the test card which is part of the maintenance routine. In another embodiment, generation of the custom thermal compensation routine may result from a user wanting to use a different/new card stock in the card printing system, with the custom thermal compensation routine being generated within minutes of the test printing on the test card of the different/new card stock.

The custom thermal compensation routine may be stored in suitable electronic storage location on the card printing system, or stored in suitable electronic storage location that is separate from the card printing system.

In an embodiment, a method of thermal printing data on a card in a card printing system having a thermal print head and a thermal print ribbon can include applying test printing, using the thermal print head and the thermal print ribbon, on a test card using at least one pre-generated stored thermal compensation routine. Thereafter, a custom or new thermal compensation routine is generated that is based on results of the applied test printing on the test card. Thereafter, a card is input and the data is printed on the card using the thermal print head and the thermal print ribbon, with the thermal print head controlled by the custom thermal compensation routine.

In another embodiment, a card printing system can include a card input, a card output, a print station that includes a thermal print head and a thermal print ribbon, and a thermal compensation routine generator connected to and controlling operation of the print station. The thermal compensation routine generator is configured to generate a new thermal compensation routine that is based on results of test printing on a test card resulting from using at least one pre-generated stored thermal compensation routine, the thermal print head and the thermal print ribbon.

### DRAWINGS

FIG. 1 is an example of a method of thermal printing described herein.

FIG. 2 depicts an example of an identification document in the form of a card that can be printed on using the techniques described herein.

FIG. 3 depicts an example of a thermal print station.

FIG. 4 schematically depicts an example of a card printing system that can utilize the techniques described herein.

FIG. 5 schematically depicts another example of a card printing system that can utilize the techniques described herein.

FIG. 6 schematically depicts another example of a card printing system that can utilize the techniques described herein.

### DETAILED DESCRIPTION

The following is a description of a card printing system (or a plastic card printing system when printing on plastic cards, or an identification document printing system, or a passport printing system when printing on a passport) having a thermal print head and a thermal print ribbon, where operation of the thermal print head is controlled using a custom (or new) thermal compensation routine, for example a custom or new heat table. The custom thermal compensation routine is generated based on an analysis, which can be manual or automated, of test printing that is applied using the thermal print head and the thermal print ribbon on a test card using at least one pre-generated thermal compensation routine. Once the custom thermal compensation routine is generated, the custom routine can then be used to print on a card, with the resulting printing being of higher quality than printing resulting from use of the pre-generated thermal compensation routine.

The card can be a plastic card which may be made entirely of plastic, or a combination of plastic and non-plastic materials. In an embodiment, the card may be made entirely of non-plastic materials such as paper or metal. In an embodiment, the card may be made of a plastic such as polycarbonate, polyvinyl chloride (PVC), polyethylene terephthalate glycol (PETG), and other plastics. In an embodiment, the cards may be ID-1 cards as defined by ISO/IEC 7810. However, other card formats such as ID-2 as defined by ISO/IEC 7810 are possible as well. In an embodiment, the printing techniques described herein can be used on other identification document substrates such as passports like a front cover page or a rear cover page of the passport, or an internal page (for example a plastic page referred to as a data page) of the passport. In an embodiment, the passports may be in an ID-3 format as defined by ISO/IEC 7810.

The term “personalization” (or the like) as used throughout the specification and claims, unless indicated otherwise, is intended to encompass operations performed on a card that includes operations that result in personalizing the card as well as operations that do not result in personalizing the card. An example of a personalization operation that personalizes the card is printing the intended card holder's image or name on the card. An example of a personalization operation that does not personalize the card is printing non-card holder graphics on the card. The term “personalize” is often used in the personalized card industry to refer to a card or other identification document that undergoes both personalization processing operations and non-personalization processing operations.

As used herein, the word “step” includes a single action within the step or multiple actions within the step.

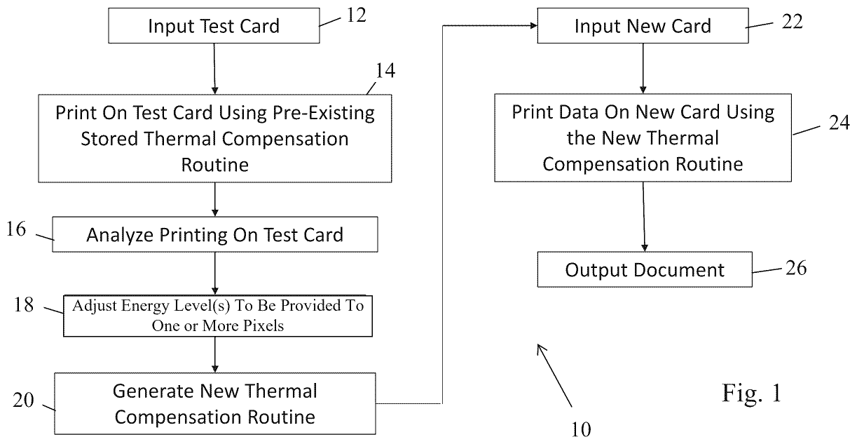

Referring to FIG. 1, an example of a method 10 of thermal printing is illustrated. In a step 12, a test card (or other test identification document) is input, for example into a card printing system. The test card may be input from an input hopper that is configured to contain one or more additional cards, or the test card may be manually input via an input slot. The construction and operation of input hoppers and input slots in card printing systems is well known in the art. The test card is then transported to a print station that has a thermal print head and a thermal print ribbon for printing on a surface of the test card. Transport of the test card is achieved using suitable transport mechanisms known in the art including rollers, belts, tabbed belts, and combinations thereof. The transport mechanisms may be configured to transport the test card in a single, forward direction, or the transport mechanisms may be reversible to transport the test card in forward and reverse directions. Card transport mechanisms in card printing systems are well known in the art including those disclosed in U.S. Pat. Nos. 6,902,107, 5,837,991, 6,131,817, and 4,995,501 and U.S. Published Application Nos. 2013/0220984 and 2018/0326763, each of which is incorporated herein by reference in its entirety. A person of ordinary skill in the art would readily understand the type(s) of card transport mechanisms that could be used, as well as the construction and operation of such card transport mechanisms.

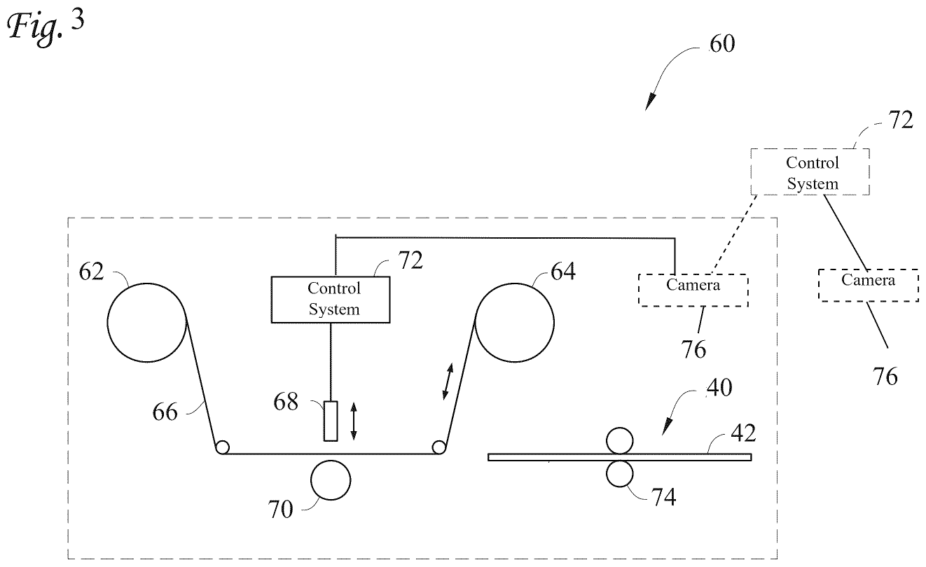

In step 14, the test card is printed on using at least one pre-generated stored thermal compensation routine that controls the thermal print head. The pre-generated thermal compensation routine may be stored on the card printing system, stored in a storage device that is interfaced with the card printing system, or stored in a location away from the card printing system. Further information on the print station is described below in FIG. 3. In addition, an example of a thermal transfer printing mechanism that performs thermal transfer printing from a thermal transfer print ribbon using a thermal print head is described in U.S. Pat. No. 10,889,129 which is incorporated herein by reference in its entirety.

The printing in step 14, which may be referred to as test printing, may be a single color (i.e. monochromatic) or multiple colors such as cyan, magenta, yellow and black (CMYK). The test printing may be one or more of text characters, one or more symbols, one or more graphics or images, one or more dots, one or more lines, one or more geometric shapes, and other printing. In an embodiment, a single test image may be printed on the test card using a single pre-generated stored thermal compensation routine. In another embodiment, a plurality of test images can be printed on the test card, with each test image printed using a different pre-generated stored thermal compensation routine.

In step 16, the test printing on the test card is analyzed. The analysis may be performed manually by a user, such as a technician, or the analysis may be automated, for example using image analysis software. If the analysis is manual, the analysis may be performed by visually analyzing a portion of or the entirety of the test printing, for example by the user using a microscope, magnifying glass, a loupe, or other magnification device, to determine the quality of the test printing under magnification. If the analysis is automated, a picture of the test printing on the test card may be captured to obtain a high-resolution image, and the picture may then be analyzed using image analysis software to determine the quality of the test printing. Image analysis software that can be used is well-known in the art. For example, the analysis, both manual and automated, can include determining if individual printed pixels in the test printing are sharp and well defined, or if there are any missing or incomplete pixels. In one specific example, a single-pixel-width line can be test printed on the test card, and the leading edge of the line can be analyzed to determine if the leading edge has an appropriately sized dot of pigment when printed using the pre-generated thermal compensation routine. When multiple test images are printed using different pre-generated stored thermal compensation routines, the printed test image that is considered to be of the best quality may be selected, with the thermal compensation routine associated with the selected printed test image then being used as a starting point to generate the new thermal compensation routine.

In step 18, based on the analysis in step 16, energy inputs to one or more pixels of the thermal print head can then be adjusted, up or down which are used to generate a custom or new thermal compensation routine in step 20. In an embodiment, the energy inputs to a plurality of pixels are adjusted. For at least one or more pixels, the energy levels from the pre-generated heat table of the pre-generated stored thermal compensation routine may be adjusted upward, for at least one or more pixels the energy levels from the pre-generated heat table of the pre-generated stored thermal compensation routine may be adjusted downward, and for at least one or more pixels the energy levels from the pre-generated heat table of the pre-generated stored thermal compensation may be unchanged. The adjustments of the energy levels of the pixels can result from manual inputs by a user, or the adjustments of the energy levels can be automated.

In an embodiment, a single point on the test printing can be analyzed and the energy level provided to the pixel (which may be referred to as a target pixel) corresponding to that single point can be adjusted. In another embodiment, at least two points on the test printing can be analyzed and the energy levels provided to the target pixels corresponding to the at least two points can be adjusted. In another embodiment, at least three points on the test printing can be analyzed and the energy levels provided to the target pixels corresponding to the at least three points can be adjusted. The amount of energy that is delivered to a target pixel can be based on a number of factors including, but not limited to, the desired temperature of the target pixel, how many nearby pixels are energized contributing to the temperature of the target pixel, the prior energization history of the target pixel (for example was the target pixel on and therefore already warm, or off and therefore cold, when printing the preceding print column).

In step 20, the custom or new thermal compensation routine, in particular the new heat table, is generated using the adjusted energy levels. The custom thermal compensation routine can be generated using any suitable technique. In general, the generation of thermal compensation routines is well known in the art. An example of thermal print head compensation in a thermal print head is described in U.S. Pat. No. 5,793,403. The custom thermal compensation routine may also be generated mathematically, for example using a transfer function. In another embodiment, the custom thermal compensation routine may be generated using machine vision to gather an image of the test printing together with machine learning to analyze the test printing, determine any energy level adjustments, and generate the custom thermal compensation routine. Once the custom thermal compensation routine is generated, it may be saved in a suitable storage location, for example on the card printing system, in a portable storage device such as a USB drive that can interface with the card printing system, or in a storage location such as cloud storage remote from but able to communicate with the card printing system.

In step 22, a new card to be printed on is input. The new card can be input after the custom thermal compensation routine is generated, while the custom thermal compensation routine is being generated, or before generation of the custom thermal compensation routine begins. The input of the new card in step 22 can be achieved using the same input options as the test card in step 12. The new card is then transported to the print station for printing data on a surface of the new card.

In step 24, the data is printed on the new card using the thermal print head and the thermal print ribbon under control of the custom thermal compensation routine. The data can be any printing on a card including, but not limited to, a portrait image of a person such as the intended card holder, a background image, and/or text such as the name of the intended card holder, an account number, expiration date, and the like. In step 24, the printing may be monochromatic and/or multi-color such as CMYK.

Once the printing using the custom thermal compensation routine is complete, the card may be output to a document output in step 26. The card may be transported to the output after step 24 using transport mechanisms such as those discussed above. The output may be an output hopper that is configured to contain one or more additional cards, or the output may be an output slot. The construction and operation of output hoppers and output slots in card printing systems is well known in the art.

In an embodiment, the generation of the custom thermal compensation routine may result from an iterative process where in the method 10, steps 12-20 may be repeated multiple times, and each time energy levels of various pixels are adjusted in step 18 to hone-in on the best custom thermal compensation routine to achieve the desired print quality.

The method 10 may also include additional card processing steps. For example, between steps 12 and 14, a magnetic strip on the card may be encoded in a read/write system that is configured to read data from and/or write data to the magnetic strip on the card, and/or an integrated circuit chip on the card may be programmed using an integrated circuit chip programming system. Magnetic strip read/write systems and integrated circuit chip programming systems are disclosed, for example, in U.S. Pat. Nos. 6,902,107 and 6,695,205 the entire contents of which are incorporated herein by reference, and can be found in the MX family of central issuance systems available from Entrust Corporation of Shakopee, Minnesota. Additional processing between steps 12 and 14 may also include, but are not limited to, embossing; indenting; laminating; laser marking; applying a topcoat; a security station that is configured to apply a security feature such as a holographic foil patch to the card; and other card processing operations. In another example, additional processing may also occur between steps 24 and 26. Additional processing between steps 24 and 26 may also include, but are not limited to, embossing; indenting; laminating; laser marking; applying a topcoat; a quality control station that is configured to check the quality of personalization/processing applied to the card; a security station that is configured to apply a security feature such as a holographic foil patch to the card; and other card processing operations.

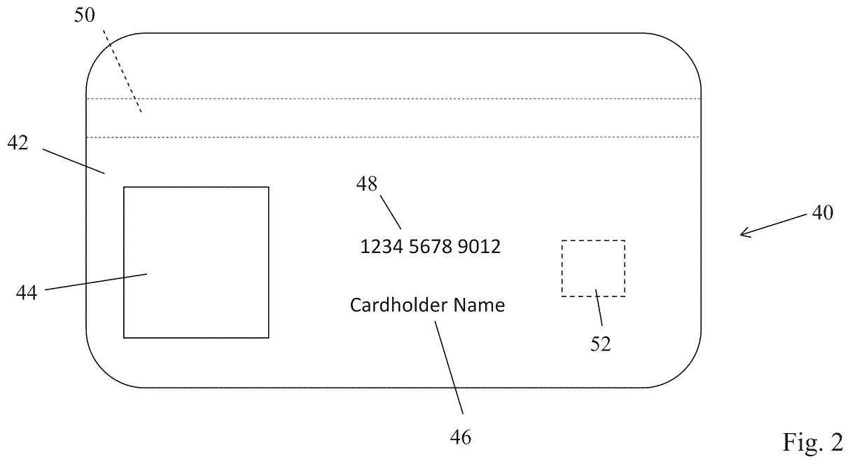

FIG. 2 illustrates an example of a card 40 which may be referred to as a plastic card if it is formed from plastic. The card 40 may be an identification card, a driver's license, a financial card including a credit and debit card, a gift card, and other personalized cards. The card 40 is depicted as including a surface 42 which may be referred to and considered as a front surface of the card. In this example, the surface 42 is the surface that is intended to be printed on. The printing can include a printed image (i.e. a portrait image) 44 of the intended holder of the card 40, where the printed image can be a monochromatic image or a multicolor image for example printed from CMYK pigments, the name 46, address and other personal data of the intended card holder, or a document number such as an account number 48. The card 40 can further include additional personal data provided on the surface 42 and/or provided on an opposite surface such as a CVV number. The additional personal data may be printed onto the card 40 using the same print station described above and/or using other known printing techniques, for example retransfer printing, laser marking, and other printing techniques known in the art of card processing. In the case of the card 40 depicted in FIG. 2, the card 40 may also include a magnetic strip 50 (often disposed on the surface that is opposite the surface 42) that can be magnetically encoded with data. The card 40 may also include an integrated circuit chip 52 that can be electronically programmed with data.

FIG. 3 illustrates an example of a thermal print station 60 that can be used in a card printing system. The print station 60 is configured to perform direct-to-card thermal printing on the card 40. However, the techniques described herein can be utilized with other types of thermal printing including, but not limited to, retransfer printing. The print station 60 includes a thermal print ribbon supply 62, a thermal print ribbon take-up 64, a thermal print ribbon 66, a thermal print head 68, a platen 70 located opposite the print head 68, and a control system 72.

The print ribbon 66 can be a monochromatic or multi-color thermal print ribbon known in the art. The print ribbon 66 is supplied from the print ribbon supply 62 and is taken up on the print ribbon take-up 64 after use. In the case of a multi-color thermal print ribbon, the print ribbon 66 may include a plurality of color panels disposed in a repeating sequence. For example, the print ribbon 66 can be a YMCK ribbon with multiple sequences of yellow (Y), magenta (M), cyan (C) and black (K) panels as is well known in the art. The YMC panels are typically dye material, while the K panel is a pigment material. In some embodiments the print ribbon 66 can include one or more additional panels associated with each sequence of color panels, including, but not limited to, panels of topcoat material (often designated as a YMCKT ribbon) and/or overlay material (often designated as a YMCKO ribbon).

The thermal print head 68 can be any thermal print head known in the art of card printing. As would be well understood by a person of ordinary skill in the art, the thermal print head 68 includes a plurality of individually energizable pixel/heating elements (not shown) each of which is selectively energizable by an electronic strobe pulse, dictated by the heat table of the thermal compensation routine, which heats the corresponding pixel element to transfer color material from one of the panels of the print ribbon 66 to the card 40. As depicted in FIG. 3, the thermal print head 68 can be moved toward the platen 70 to bring the print head 68 into position during printing in a print pass, and moved away from the platen 70 when not printing to reposition the card 40 for a next print pass.

In another embodiment, the print station 60 can include a plurality of separate monochrome thermal print ribbons (not shown), for example a Y print ribbon, an M print ribbon, a C print ribbon, a K print ribbon, etc. In addition, the print station 60 can include a corresponding plurality of thermal multiple print heads, one thermal print head associated with each monochrome print ribbon. The card 40 is transported through each monochrome print ribbon/thermal print head combination which print each respective color on the card 40 to generate the resulting multi-color image.

One or more mechanical card transport mechanisms, such as one or more pairs of transport rollers 74, transport the card 40 in the printing station 60. The card transport mechanism may be reversible to permit forward and reverse transport of the card 40 to permit implementation of multiple print passes past the print head 68. Mechanical card transport mechanism(s) for transporting cards in card printing systems are well known in the art. Additional examples of card transport mechanisms that could be used are known in the art and include, but are not limited to, transport belts (with tabs and/or without tabs), vacuum transport mechanisms, transport carriages, and the like and combinations thereof. Card transport mechanisms are well known in the art including those disclosed in U.S. Pat. Nos. 6,902,107, 5,837,991, 6,131,817, and 4,995,501 and U.S. Published Application No. 2007/0187870, each of which is incorporated herein by reference in its entirety. A person of ordinary skill in the art would readily understand the type(s) of card transport mechanisms that could be used, as well as the construction and operation of such card transport mechanisms.

With continued reference to FIG. 3, the control system 72 communicates directly or indirectly with the thermal print head 68 to control operation of the print head 68. The control system 72 includes electronic storage that stores one or more pre-generated thermal compensation routines. The same electronic storage, or a different electronic storage, may also store the custom thermal compensation routine. The control system 72 may be part of the print station 60 and can be located within a housing (indicated in dashed lines) of the print station 60, or the control system 72 can be remote from (i.e. physically separate from) the print station 60 and located outside the housing as indicated in broken lines in FIG. 3. The control system 72 may be configured to generate the custom thermal compensation routine for example using a thermal compensation routine generator included therein. The control system 72 may also process print data and generate data in the form of strobe pulses to control the energization of the individually energizable heating elements of the thermal print head 68, using one or more of the pre-generated thermal compensation routines or the custom thermal compensation routine, to generate the printing on the card 40. The control system 72 may also control driving of the ribbon supply 62 and/or the print ribbon take-up 64 during printing, control the movements of the thermal print head 68 during printing, and/or control operation of the transport rollers 74 during printing. Alternatively, the generation of the custom thermal compensation routine, the driving of the ribbon supply 62 and/or the print ribbon take-up 64, the movements of the thermal print head 68, and/or the operation of the transport rollers 74, may be controlled by a separate control system of the print station 60 either within the print station 60 or remote from the print station 60. For example, in some embodiments, when the control system is remote from the print station 60, only the portion of the control system that generates the custom thermal compensation routine, processes print data and generates the strobe pulses to control the energization of the individually energizable heating elements of the thermal print head 68, based on the pre-generated and custom thermal compensation routines, may be remote or outside of the print station. Other functions of the control system 72, such as control of the card transport mechanism(s), control of movement of the print ribbon 66 and the movement of the thermal print head 68, and the like, may be on or in the print station 60.

With continued reference to FIG. 3, a camera 76 may also be provided that is in communication with the control system 72. The camera 76 may be internal to and part of the print station 60, or the camera 76 may be separate from and external to the print station 60. If present, the camera 76 may be used in the automatic analysis of the test printing on the test card. The camera 76 is used to capture an image of the test printing on the test card. The captured image is then fed to the control system 72 which analyzes the test printing and based on the analysis generates the custom thermal compensation routine using the thermal compensation routine generator which is used to control the print head 68 when subsequently printing on cards.

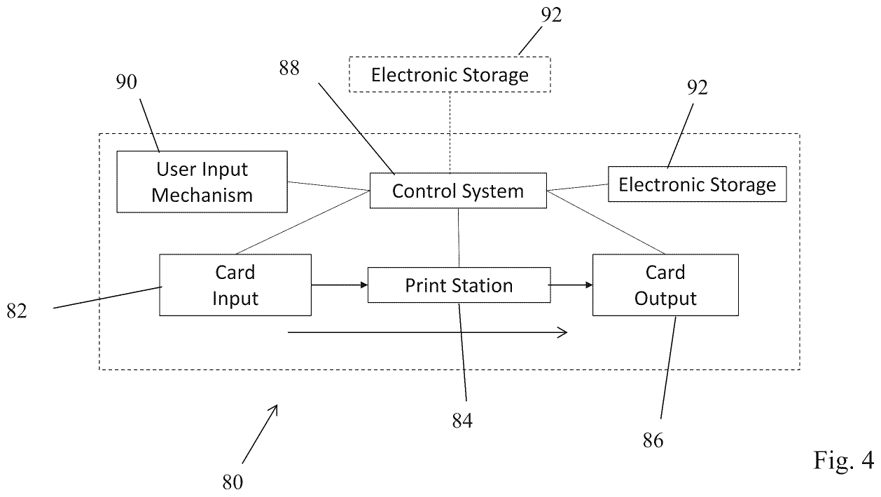

Referring to FIG. 4, an example of a card printing system 80 that can implement the method 10 described in FIG. 1 is illustrated. The system 80 is depicted as including a card input 82, a print station 84, a document output 86, a control system 88, a user input mechanism 90, and electronic storage 92. In the system 80, the card generally travels in a direction indicated by the arrow from the input 82 to the print station 84 and then to the output 86.

The card input 82 may be configured to hold a plurality of cards (or other identification documents) waiting to be processed and to input each card one-by-one for subsequent processing. One of the cards in the card input 82 may be the test card. Alternatively, the card input 82 may be an input slot through which an individual card, including the test card and subsequent cards, is manually fed into the system 80.

The print station 84 is a thermal print station with a thermal print head and a thermal print ribbon. The thermal print head and the thermal print ribbon may have a configuration like in the print station 60 described above for FIG. 3.

The document output 86 is depicted as being located at the end of the processing line of the system 80. The output 86 may be configured to hold a plurality of the cards after processing has been completed. Alternatively, the document output 86 may be an output slot through which an individual card, including the test card, is output from the system 80.

The control system 88 is connected to and controls operation of the input 82, the print station 84, and the output 86. The control system 88 may also receive electronic feedback signals from one or more of the input 82, the print station 84 and the output 86. Like discussed above for FIG. 3, the control system 88 may integrated into and be physically part of the system 80. Alternatively, the control system 88 may be physically separate from the system 80, but suitably connected to the system 80 to be able to control at least the print station 84. The control system 88 may perform functions similar to the control system 72 in FIG. 3.

The user input mechanism 90 is connected to the control system 88 and is configured to allow one or more user inputs into the system 80. The user input mechanism 90 can be any mechanism that allows user inputs into the system 80. For example, the user input mechanism 90 may be a touchscreen panel, input buttons, a microphone for receiving voice commands, and any other form of user input mechanism.

The system 80 also includes or is in communication with electronic storage 92 which may be internal to and part of the system 80 or external to and separate from the system 80. The broken line boundary in FIG. 4 indicates a housing, skin or shell of the system 80 that contains the elements depicted within the broken line. The electronic storage 92 is in communication with (or may be part of) the control system 88 and stores the pre-generated thermal compensation routine(s) and may also store the custom thermal compensation routine.

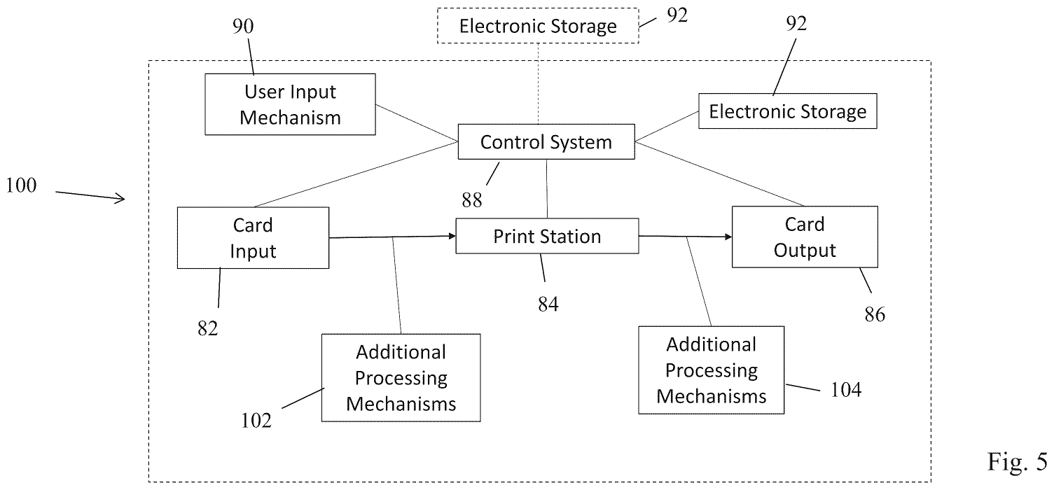

Referring to FIG. 5, another example of a card printing system 100 that can implement the method 10 described in FIG. 1 is illustrated. In FIG. 5, elements that are the same as or similar to elements in FIG. 4 are referenced using the same reference numerals. In FIG. 5, the system 100 includes the same elements as in the system 80 of FIG. 4. However, in FIG. 5, the system 100 is depicted as including optional one or more additional processing mechanisms 102 and optional one or more additional processing mechanisms 104. The optional additional processing mechanisms 102 may be located between the input 82 and the print station 84 and can include, but are not limited to, an embossing mechanism; an indenting mechanism; a laminating mechanism; a laser marking mechanism; a topcoat applicator; a security station that is configured to apply a security feature such as a holographic foil patch to the card; a flipping mechanism to flip the card 180 degrees; and other card processing mechanisms. The optional additional processing mechanisms 104 may be located between the print station 84 and the output 86 and may include, but are not limited to, an embossing mechanism; an indenting mechanism; a laminating mechanism; a flipping mechanism to flip the card 180 degrees; a laser marking mechanism; a topcoat applicator; a quality control station that is configured to check the quality of personalization/processing applied to the card; a security station that is configured to apply a security feature such as a holographic foil patch to the card; and other card processing mechanisms.

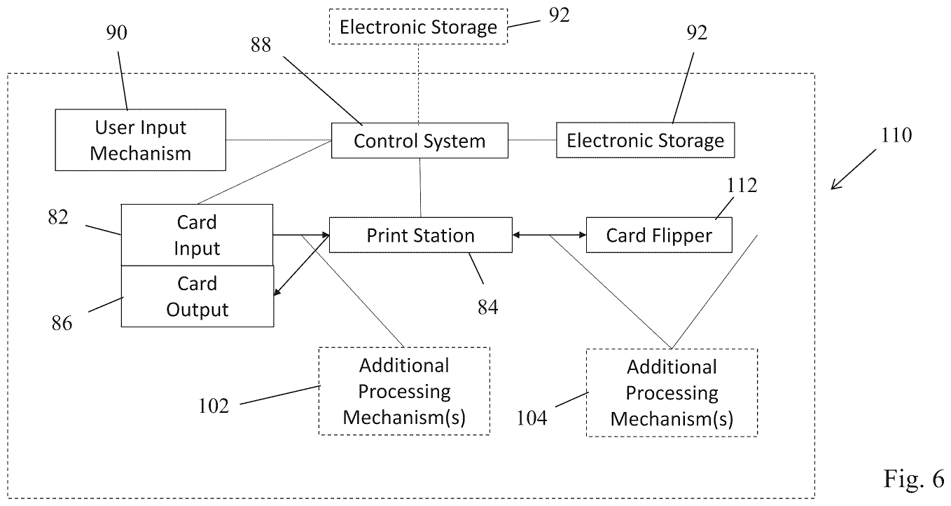

Referring to FIG. 6, another example of a card printing system 110 that can implement the method 10 described in FIG. 1 is illustrated. In FIG. 6, elements that are the same as or similar to elements in FIGS. 4 and 5 are referenced using the same reference numerals. In FIG. 6, the system 110 differs from the system 80 in FIG. 4 and from the system 100 in FIG. 5 in that the card input 82 and the card output 86 are each located at the same end of the system 110. In addition, a card flipper 112 may be located at the end of the system 110 opposite the input 82 and the output 86. In operation, a card that is input is transported to the print station 84 for printing. The card may then be transported in a reverse direction to the output 86 if printing is complete. If duplex (i.e. two-sided) printing is required, the card is transported from the print station 84 to the card flipper 112 which flips the card 180 degrees, with the card then transported in reverse back to the print station 84 to print on the reverse side and then transported in reverse to the output.

The input 82 and the output 88 in the systems 80, 100, 110 of FIGS. 4-6 can be positioned in the systems at any locations suitable for performing their input and output functions. Locations of the input 82 and the output 86 in the systems of FIGS. 4-6 other than those depicted are possible.

The systems in FIGS. 4-6 may be configured as large volume batch card personalization machines, often configured with multiple processing stations or modules, typically referred to as a central issuance system, that processes multiple cards or other documents at the same time and are designed to personalize documents in relatively large volumes, for example measured in the high hundreds or even thousands per hour. An example of a central issuance system is the MX or MPR-lines of central issuance systems available from Entrust Corporation of Shakopee, Minnesota. Additional examples of central issuance systems are disclosed in U.S. Pat. Nos. 4,825,054, 5,266,781, 6,783,067, and 6,902,107, all of which are incorporated herein by reference in their entirety. Alternatively, the systems in FIGS. 4-6 may be configured as desktop card or document printers that have a relatively small footprint intended to permit the desktop card printer to reside on a desktop and that is designed to personalize cards and other documents in relatively small volumes, for example measured in tens or low hundreds per hour. An example of a desktop card printer is the CD800 Card Printer available from Entrust Corporation of Shakopee, Minnesota. Additional examples of desktop card printers are disclosed in U.S. Pat. Nos. 7,434,728 and 7,398,972, each of which is incorporated herein by reference in its entirety.

The examples disclosed in this application are to be considered in all respects as illustrative and not limitative. The scope of the invention is indicated by the appended claims rather than by the foregoing description; and all changes which come within the meaning and range of equivalency of the claims are intended to be embraced therein.

1. A method of thermal printing data on a card in a card printing system having a thermal print head and a thermal print ribbon, comprising:
applying test printing, in the card printing system using the thermal print head and the thermal print ribbon, on a test card using at least one pre-generated stored thermal compensation routine;
thereafter generating a new thermal compensation routine that is based on results of the applied test printing on the test card, and storing the new thermal compensation routine;
thereafter inputting the card and printing, in the card printing system using the thermal print head and the thermal print ribbon, the data on the card using the new thermal compensation routine, and thereafter outputting the card.

2. The method of claim 1, wherein applying test printing comprises:
printing a plurality of test images on the test card, each test image is printed using a different pre-generated stored thermal compensation routine; and
generating the new thermal compensation routine based on one of the printed test images.

3. The method of claim 2, comprising allowing entry of a selection of the one printed test image, and generating the new thermal compensation routine based on the entered selection of the one printed test image.

4. The method of claim 3, wherein the entry is a manual entry via a user or an automated entry.

5. The method of claim 1, wherein generating the new thermal compensation routine comprises generating a new heat table that controls energy delivered to individual heat elements of the thermal print head.

6. The method of claim 1, wherein the test printing on the test card is monochromatic or multi-color.

7. The method of claim 1, wherein the data comprises a portrait image of a person, a background image, and/or text.

8. The method of claim 1, comprising storing the new thermal compensation routine in an electronic storage location on the card printing system.

9. The method of claim 1, comprising storing the new thermal compensation routine in an electronic storage location that is separate from the card printing system.

10. The method of claim 1, further comprising using the card printing system to one or more of:
program an integrated circuit chip on the card; and
encode data on a magnetic strip on the card.

11. The method of claim 10, further comprising using the card printing system to one or more of:
apply a laminate to the card;
laser mark the card;
emboss the card;
indent a character on the card.

12. The method of claim 1, wherein the card is a plastic card, and the test card is a plastic test card.

13. A card printing system that prints data on a card, comprising:
a card input;
a card output;
a print station that includes a thermal print head and a thermal print ribbon for printing the data on the card;
a thermal compensation routine generator connected to and controlling operation of the print station; the thermal compensation routine generator is configured to generate a new thermal compensation routine that is based on results of test printing on a test card resulting from using at least one pre-generated stored thermal compensation routine, the thermal print head and the thermal print ribbon.

14. The card printing system of claim 13, wherein the test printing comprises a plurality of test images printed on the test card, each test image is printed using a different pre-generated stored thermal compensation routine.

15. The card printing system of claim 13, wherein the thermal compensation routine generator is configured to generate a new heat table that controls energy delivered to individual heat elements of the thermal print head.

16. The card printing system of claim 13, wherein the thermal print ribbon is a monochromatic thermal print ribbon or a multi-color thermal print ribbon.

17. The card printing system of claim 13, further comprising one or more of:
an integrated circuit chip programming mechanism that is configured to program an integrated circuit chip on the card, the integrated circuit chip programming mechanism is positioned between the card input and the card output; and
a magnetic strip encoding mechanism that is configured to magnetically encode data on a magnetic strip on the card, the magnetic strip encoding mechanism is positioned between the card input and the card output.

18. The card printing system of claim 17, further comprising one or more of:
a laminating mechanism that is configured to apply a laminate to the card, the laminating mechanism is positioned between the card input and the card output;
a laser marking mechanism that is configured to laser mark the card, the laser marking mechanism is positioned between the card input and the card output;
an embossing mechanism that is configured to emboss the card, the embossing mechanism is positioned between the card input and the card output;
an indenting mechanism that is configured to indent the card, the indenting mechanism is positioned between the card input and the card output.

19. The card printing system of claim 13, wherein the card is a plastic card, and the test card is a plastic test card.
